(19) United States
(12) Patent Application Publication
(10) Pub. No.: US 2010/0295947 A1
(43) Pub. Date: Nov. 25, 2010

(54) Multi-Spectral Color and IR Camera Based on Multi-Filter Array

(76) Inventor: Pierre Benoit Boulanger, Edmonton (CA)

Correspondence Address: ULMER & BERNE, LLP;ATTN: DIANE BELL, 600 VINE STREET, SUITE 2800, CINCINNATI, OH, 45202-2409, US

(21) Appl. No.: 12/784,810

(22) Filed: May 21, 2010

Related U.S. Application Data
(60) Provisional application No. 61/180,388, filed on May 21, 2009.

(51) Int. Cl. H04N 5/33

(52) U.S. Cl. 348/164; 348/E05.09

(57) ABSTRACT

A color filter array is provided that includes a mosaic of two new filters that are sensitive only to a narrow band of near infrared light centered around 850 nm. In one embodiment, the color filter array is provided for a two-dimensional CMOS sensor device, the filter array including a filter arrangement of green, blue, green, red, infrared and infrared color filters. A de-mosaicing process can be used to create a full-resolution color image from the image detected by the CMOS sensor through the color filter array.

### CROSS-REFERENCE TO RELATED APPLICATIONS

This application claims priority of U.S. provisional patent application Ser. No. 61/180,388 filed May 21, 2009, and hereby incorporates the same provisional application by reference herein in its entirety.

### TECHNICAL FIELD

The present disclosure is related to the field of optical imaging devices, in particular, multi-spectral color filter arrays for use on sensors in digital imaging devices.

### BACKGROUND

A color image requires at least three colors sampled at each pixel location to represent an estimate of the real color spectrum at the pixel location. In theory, a color camera should have three separate sensors at each pixel location to make these measurements. To reduce size and cost, many cameras today use a single two-dimensional (“2D”) sensor with a color filter array (“CFA”) placed in front of the sensor. A CFA is a mosaic of tiny coloured filters placed over a photo sensor organized in pixels to capture color information in the visible spectrum.

This color filter array allows only one color to be measured at each pixel. This means that an estimate of the missing two color values at each pixel must be performed using a process known as “de-mosaicing”. The most common array that is used is the Bayer color pattern as shown in FIG. 1. Because the pixels are not defined in the standard red-green-blue (“RGB”) format, an interpolation or de-mosaicing process must be used. The interpolation process is used to create a full-resolution color image that would be similar to a scheme using three charge-coupled devices (“CCD”) as normally used in professional cameras. Regular color filter arrays for digital cameras, camcorders, and scanners are known to use the Bayer filter mosaic arrangement of green-red-green-blue (“GRGB”) where the green pixel sampling is doubled to deal with human higher sensitivity towards amber and green.

It is, therefore, desirable to provide a color filter array for use in digital imaging devices, such as digital cameras, camcorders and scanners, that provide full-resolution RGB color imaging comparable to CCDs used in professional cameras.

### SUMMARY

A new design of a color filter array is provided for use with digital imaging devices such as digital cameras, camcorders, scanners and any other similar imaging device as well known to those skilled in the art, the color filter array comprising a mosaic of color filters in the following arrangement: green-red-green-blue-infrared-infrared (“GRGBII”). This CFA can comprise two new infrared filters that are sensitive only to a narrow band of near infrared centered around 850 nm in some embodiments for standard illumination systems, and around 1500 nm in other embodiments, for more advanced illumination systems. With this filter arrangement, similar performance can be obtained to the standard Bayer green-red-green-blue filters used for normal imaging used in standard color interpolation schemes as found in commercial cameras. The CFA as described herein can preserve green over-sampling to maintain the color balance of the interpolated image. In one embodiment, two band limited infrared (“IR”) filters can be aligned in front of each corresponding pixel; the sensor pixels having been enhanced through a doping or coating process to improve their sensitivity to near-IR light for a band or range between 850 nm and 1625 nm. Without the doping or coating process, the sensitivity of silicon can be very low at these wavelengths. In another embodiment, the IR pixels can be doubled to further improve the sensitivity to IR light. By using this narrow IR band sensitivity, the visible spectrum can be separated from the near IR images to allow the user to control the illumination of the image that can be used for a number of functions including, but not limited to, target tracking, stereo photogrammetry, foreground/background segmentation and product identification among others known to those skilled in the art. Basically, the CFA as provided for herein can be used in any application where one needs to separate the visible spectrum from user-controlled lighting.

Broadly stated, a filter array is provided for a complementary metal-oxide semiconductor (“CMOS”) light sensor device for use in a digital imaging device, comprising a mosaic of green, red, green, blue, infrared and infrared color filters.

Broadly stated, a digital imaging device is provided having a CMOS light sensor device, the CMOS light sensor device comprising a filter array comprising a mosaic of green, red, green, blue, infrared and infrared color filters.

Broadly stated, a digital imaging system is provided, comprising: a digital imaging device having a CMOS light sensor device, the CMOS light sensor device further comprising a filter array comprising a mosaic of green, red, green, blue, infrared and infrared color filters, the digital imaging device configured to produce a signal corresponding to light passing through the filter array onto the light sensor device; a pixel digitizer operatively coupled to the digital imaging device, the pixel digitizer configured to digitize the signal produced by the digital imaging device into red, green, blue and infrared pixels; a pixel de-mosaicing processor operatively coupled to the pixel digitizer, the pixel de-mosaicing processor configured to separate the red, green and blue pixels from the infrared pixels from the digitized signal produced by the pixel digitizer; a color frame buffer operatively coupled to the de-mosaicing processor, the color configured to buffer the red, green and blue pixels; an infrared frame buffer operatively coupled to the de-mosaicing processor, the color configured to buffer the infrared pixels; a video interface processor operatively coupled to the color frame buffer and to the infrared frame buffer, the video interface processor configured to produce a color video signal from the buffered red, green and blue pixels produced by the color frame buffer and to produce an infrared video signal from the buffered infrared pixels produced by the infrared frame buffer; and a clock operatively coupled to the pixel digitizer and to the video interface processor, the clock configured to synchronize the operation of the pixel digitizer and the video interface processor.

Broadly stated, a method is provided for de-mosaicing red, green, blue and infrared pixels from a signal produced by a CMOS light sensor device, the signal corresponding to light passing through a filter array onto the light sensor device, the filter array comprising a mosaic of green, red, green, blue, infrared and infrared color filters, the method comprising the steps of: digitizing the signal to produce a plurality of digitized pixels, each digitized pixel corresponding to light passing through one of the green, red, green, blue, infrared and infrared color filters of the color filter array onto a pixel of the light sensor device; applying a red pixel de-mosaicing algorithm to each digitized red pixel to determine the relative strength of red, green, blue and infrared light components at each digitized red pixel; applying a green pixel de-mosaicing algorithm to each digitized green pixel to determine the relative strength of red, green, blue and infrared light components at each digitized green pixel; applying a blue pixel de-mosaicing algorithm to each digitized blue pixel to determine the relative strength of red, green, blue and infrared light components at each digitized blue pixel; and applying an infrared pixel de-mosaicing algorithm to each digitized infrared pixel to determine the relative strength of red, green, blue and infrared light components at each digitized infrared pixel.

### BRIEF DESCRIPTION OF THE DRAWINGS

FIG. 1 is a block diagram depicting the color filter array mosaic arrangement of a prior art Bayer filter.

FIG. 2 is a block diagram depicting the novel color filter array mosaic arrangement described herein in accordance with one embodiment.

FIG. 3 is a block diagram depicting a color filter array de-mosaicing a red color pixel.

FIG. 4 is a block diagram depicting a color filter array de-mosaicing a green color pixel.

FIG. 5 is a block diagram depicting a color filter array de-mosaicing a blue color pixel.

FIG. 6 is a block diagram depicting a color filter array de-mosaicing an infrared color pixel.

FIG. 7 is a block diagram depicting an infrared mask for doping CMOS sensor with Germanium using low-pressure chemical vapor deposition (“LPCVD”) to improve near IR sensitivity.

FIG. 8 is a block diagram depicting a camera system comprising the color filter array of FIG. 2.

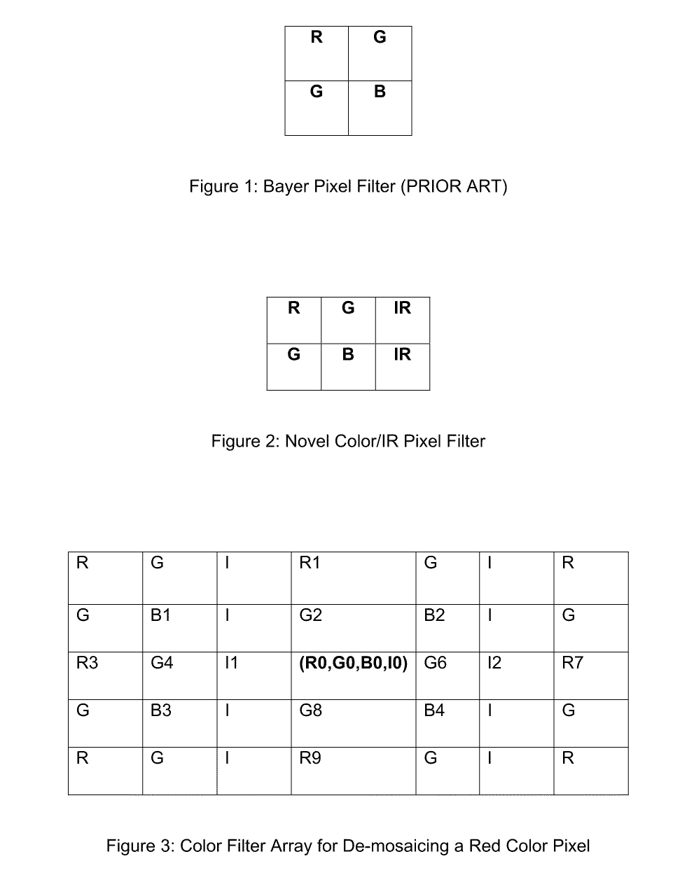

### DETAILED DESCRIPTION

A color filter array is provided that comprises two extra pixels that are only sensitive to near infrared (“IR”) light. By using this narrow band sensitivity to IR light, the visible spectrum detect at a sensor pixel can be separated from near IR images to allow for user control of illumination, which can be used for target tracking, stereo photogrammetry, foreground/background segmentation, product identification, and many more applications without the need for complex synchronization between two cameras (for example, a color camera and an IR camera). Basically, any applications where one needs to separate the visible spectrum from user-controlled lighting can be used with this new camera arrangement.

### De-Mosaicing Algorithm for Color/IR Array

In the proposed configuration, a column to the standard Bayer configuration can be added, which is only sensitive to a narrow band of light near the lower infrared spectrum, and as illustrated in FIG. 2. As with most Bayer filter equipped cameras, it is necessary for those pixels to interpolate the normal RGB values differently. There are many schemes to convert a Bayer array into a normal RGB image in the literature. One can find in Gunturk et al. (2005) [1] an excellent review of various de-mosaicing techniques.

In one embodiment of the color filter array described herein, an extra column of filters can be added to the Bayer filter array that are sensitive to only near IR light. In another embodiment, the method for de-mosaicing can comprise the steps of detecting a local edge, and interpolating color only along the edge of the pixel instead of across it. Edges can be detected only horizontally or vertically, and the interpolation can be used only on the green channel since it has more information.

In operation, light passing through the color filter array lands on the CMOS light sensor device. In one embodiment, each of the color filters of the color filter array can be configured to correspond to an individual pixel on the CMOS device. The CMOS device can produce a signal corresponding to light passing through a color filter of the color filter array onto any particular pixel. Thus, each pixel on the CMOS device is exposed to light after it has passed through a red, green, blue or infrared color filter of the color filter array. The signal produced by the CMOS device can then be digitized to produce a plurality of digitized pixels whereby each digitized pixel can correspond to light passing through a red, green, blue or infrared color filter onto a pixel of the CMOS device.

In order to determine the relative strengths of red, green, blue and infrared light components at each pixel of the CMOS device, a de-mosaicing algorithm can be implemented on each digitized pixel to determine the red, green, blue and infrared color components of the light incident on that pixel. The method of de-mosaicing the digitized pixels can start by inspecting every pixel and, depending on the type of the pixel (R, G, B, or I), a color-specific algorithm can be used to determine the interpolation necessary to compute the missing colors components at that pixel.

For example, if the current digitized pixel is red, its R component can be set to R0 and the remaining color components can be interpolated using a window of 7 pixels in the horizontal direction and 5 pixels in the vertical. The interpolation function can be based on a simple averaging technique.

Referring to FIG. 3, a red pixel can be de-mosaiced using the following red pixel algorithm:

1. R0=R0

2. ΔH=|R3−R7|/3, and ΔV=|R1−R9|/2

3. if (ΔH>ΔV), G0=(G2+G8)/2

4. else, G0=(2×G6+G4)/3

5. B0=((B1+B3)/2+B2+B4)/3

6. I0=(2×I1+I2)/3

where R0 is the central pixel and Rₙ, Gₙ, Bₙ and Iₙ are the neighbouring pixels in the window as illustrated in FIG. 3. Because uniformity assumption cannot always be preserved, the vertical (“ΔV”) and horizontal (“ΔH”) red color gradient can be computed and the green interpolation (“G0”) can be determined based on the relative values between ΔV and ΔH.

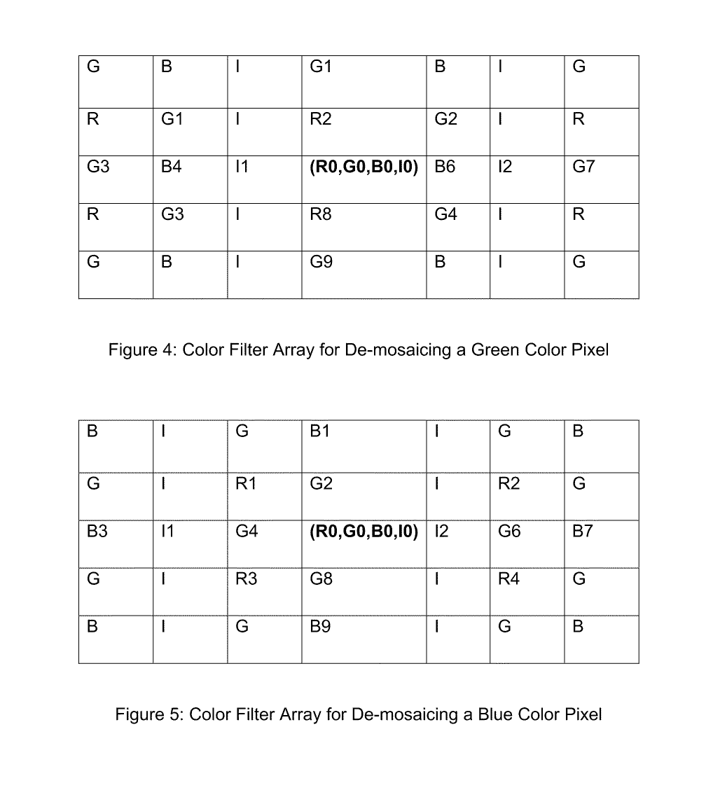

Referring to FIG. 4, a green pixel can be de-mosaiced using the following green pixel algorithm:

1. R0=(R2+R8)/2

2. G0=G0

3. B0=(2×B6+B4)/3

4. I0=(2×I1+I2)/3

where G0 is the central pixel and Rₙ, Gₙ, Bₙ and Iₙ are the neighbouring pixels in the window as illustrated in FIG. 4.

Referring to FIG. 5, a blue pixel can be de-mosaiced using the following blue pixel algorithm:

1. R0=((R2+R4)/2+(R1−R3))/3

2. ΔH=|B3−B7|/3 and ΔV=|B1−B9|/2

3. if (ΔH>ΔV)G0=(G2+G8)/2

4. else if (ΔV>ΔH)G0=(2×G4+G6)/3

5. B0=B0

6. I0=(I1+2×I2)/3

where B0 is the central pixel and Rₙ, Gₙ, Bₙ and Iₙ are the neighbouring pixels in the window as illustrated in FIG. 5. Because uniformity assumption cannot always be preserved, the vertical (“ΔV”) and horizontal (“ΔH”) blue color gradient can be computed and the green interpolation (“G0”) can be determined based on the relative values between ΔV and ΔH.

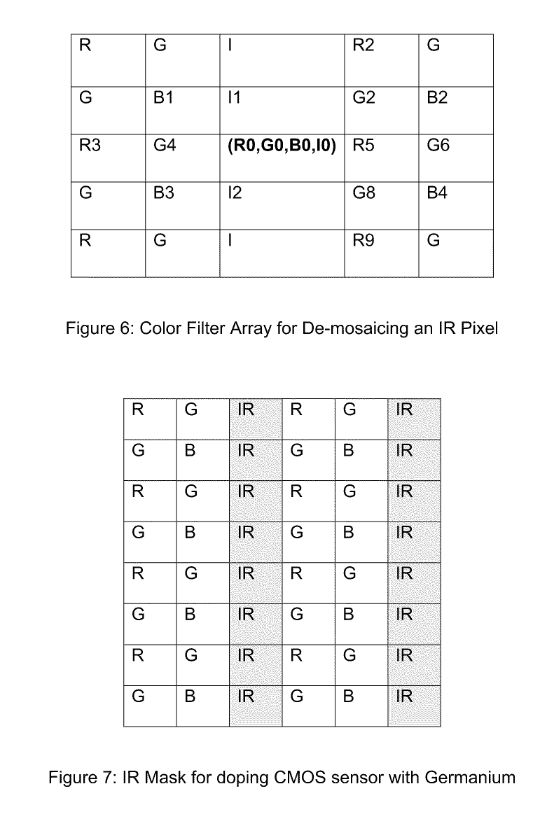

Referring to FIG. 6, an infrared pixel can be de-mosaiced using the following infrared pixel algorithm:

1. R0=(2×R5+R3)/3

2. G0=((G2+G8)/2+G4)/2

3. B0=((B2+B4)/2+(B1+B3))/3

4. I0=(I0+I1+I2)/3

where I0 is the central pixel and Rₙ, Gₙ, Bₙ and Iₙ are the neighbouring pixels in the window as illustrated in FIG. 6.

In applying the foregoing color-specific algorithms on each digitized pixel, the red, green, blue and infrared color components of the light incident on each pixel of the CMOS device can be determined.

In another embodiment, a digital imaging device containing a CMOS light sensor device, such as a digital camera, can be equipped with a color filter array as described above. In so doing, the digital camera can then emulate the performance of professional cameras using CCDs.

### Improved Sensitivity of IR Pixels for Near IR Spectrum by CMOS Germanium Doping

In addition to a new camera configuration that can be provided using the CFA described above, one can improve the IR pixel sensitivity of standard complementary metal-oxide semiconductor (“CMOS”) devices to near infrared wavelength. It has been shown that near-infrared photo-detectors can be fabricated using standard CMOS processes in conjunction with a multilayer growth of Si/SiGe_{0.06} using low-pressure chemical vapor deposition (“LPCVD”) [2]. With an accumulation of germanium atoms at the crest of such features and commensurate high germanium concentration, one can improve the long wavelength detection sensitivity of photo-detectors in the near infrared range. It has also shown that the minimum energy gap of a CMOS device doped by Germanium could be modified to be 0.88 eV corresponding to a germanium concentration of around 15%. In addition, it has been shown that a silicon sensor that has been specially treated with a phosphor coating can change its sensitivity from the visible light spectrum to a narrow band between 1460 to 1625 nm. In some embodiments, the phosphor coating can comprise “anti-stokes” phosphor, where “anti-stokes”refers to an emission process that does not conform to Stoke's second law that a material's fluorescence emission is lower in photon energy than the absorbed photon energy. In some embodiments, the phosphor can comprise Y₂O₂S:Er,Yb; YF₃:Er,Yb; NaYF₄:Er,Yb; or La₂O₂S:ErYb or a related up conversion matrix, for example.

Using this coating technique, commercial IR cameras can be available at a cost much lower than seen with other cameras having detectors based on Germanium technologies. Outside of the new filter alignment, this is a process that can be done on the IR columns of a standard CMOS device. The mask used in the standard Bayer fabrication process, as well known to those skilled in the art, is shown in FIG. 7 in a modified configuration to provide the Germanium doping to a CMOS device. Using this mask, one skilled in the art can perform such a doping process on a CMOS device easily. In other embodiments, similar techniques can be used based on a phosphor coating described in [3] if the application requires IR illumination in the range of 1460 nm to 1625 nm.

### Camera Controller

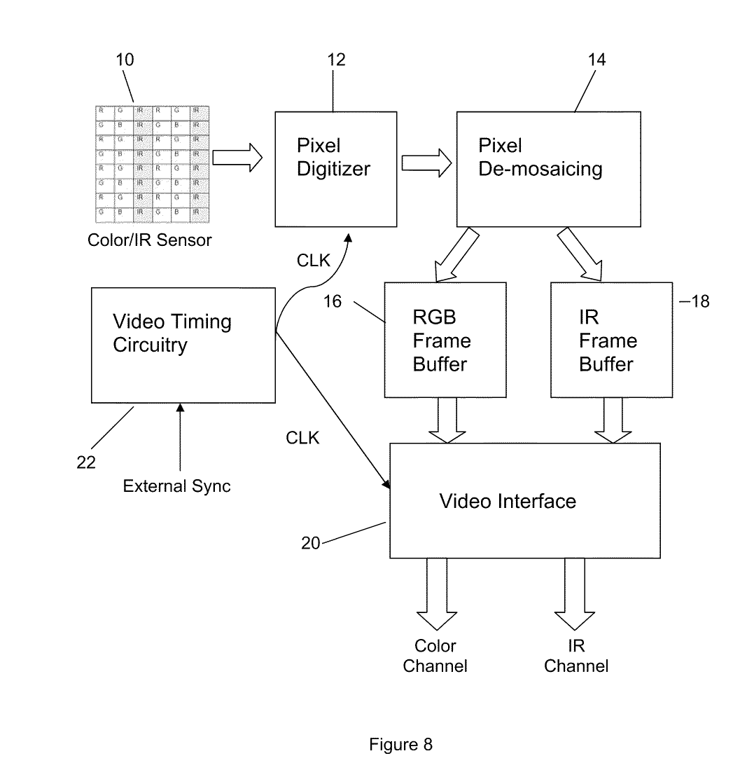

One can see from FIG. 8, a block diagram of one embodiment of a camera system is illustrated that can be implemented in accordance with the CFA and de-mosaicing method described herein. The system can be composed of sensor 10 (the new CMOS device described above), standard gen-locked pixel digitizer 12, pixel de-mosaicing processor 14, two frame buffers 16 and 18 (color and IR) and gen-locked video interface processor 20 to transfer the two signals as a normal color image and a black/white IR image. In this configuration, pixel digitizer 14 can convert the signal of each pixel into digital form using a video rate, eight-bit analog to digital converter that can be synchronized by an internal clock or external video timing clock 22. The resulting converted pixels can then be sent to de-mosaicing processor 14 that can perform the interpolation algorithm described above. The resulting pixels (R,G,B,I) can then be stored into two local frame buffers 16 and 18, one for the color image (RGB) and one for the IR image (I). Using frame buffers 16 and 18, video processor 20 can then generate two standard NTSC video channels that can be synchronized by an internal clock or by external video timing clock 22. The RGB channel can have a resolution of 24 bits per pixel, whereas the IR channel can have a resolution of 8 bits per pixel.

Although a few embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the scope of the invention is defined and limited only by the claims that follow.

### REFERENCES

The following documents are hereby incorporated into this application by reference in their entirety.
[1] B. K. Gunturk, J. Glotzbach, R. W. Schafer and R. M. Mersereau, “Demosaicking: color filter array interpolation,” IEEE Signal Processing Magazine (Special Issue on Color Image Processing), January 2005, pp. 44-54.
[2] P. Iamraksa, N. S. Lloyd, D. M. Bagnall, “Si/SiGe near-infrared photodetectors grown using low pressure chemical vapour deposition”, J Mater Sci: Mater Electron (2008) 19:179-182.
[3] J. Creasey, G. Tyrell, and J. De Mattos, Infrared camera with phosphor coated CCD, European Patent EP1199886, 2004.

What is claimed is:

1. A filter array for a complementary metal-oxide semiconductor (“CMOS”) light sensor device for use in a digital imaging device, comprising a mosaic of green, red, green, blue, infrared and infrared (“IR”) color filters.

2. The filter array as set forth in claim 1, further comprising a matrix of 3 columns and 2 rows of color filters.

3. The filter array as set forth in claim 2, wherein the matrix further comprises a top row of red, green and infrared color filters, and a bottom row of green, blue and infrared color filters.

4. The filter array as set forth in claim 1, wherein the IR color filters are sensitive to IR light having a wavelength ranging from 850 nm to 1625 nm.

5. A digital imaging device having a complementary metal-oxide semiconductor (“CMOS”) light sensor device, the CMOS light sensor device comprising a filter array comprising a mosaic of green, red, green, blue, infrared and infrared (“IR”) color filters.

6. The digital imaging device as set forth in claim 5, wherein the filter array further comprises a plurality of matrices, each matrix comprising 3 columns by 2 rows of color filters.

7. The digital imaging device as set forth in claim 6, wherein each of the plurality of matrices further comprises a top row of red, green and infrared color filters, and a bottom row of green, blue and infrared color filters.

8. The digital imaging device as set forth in claim 5, wherein the IR color filters are sensitive to IR light having a wavelength ranging from 850 nm to 1625 nm.

9. A digital imaging system, comprising:
a) a digital imaging device having a complementary metal-oxide semiconductor (“CMOS”) light sensor device, the CMOS light sensor device further comprising a filter array comprising a mosaic of green, red, green, blue, infrared and infrared (“IR”) color filters, the digital imaging device configured to produce a signal corresponding to light passing through the filter array onto the light sensor device;
b) a pixel digitizer operatively coupled to the digital imaging device, the pixel digitizer configured to digitize the signal produced by the digital imaging device into red, green, blue and infrared pixels;
c) a pixel de-mosaicing processor operatively coupled to the pixel digitizer, the pixel de-mosaicing processor configured to separate the red, green and blue pixels from the infrared pixels from the digitized signal produced by the pixel digitizer;
d) a color frame buffer operatively coupled to the de-mosaicing processor, the color frame buffer configured to buffer the red, green and blue pixels;
e) an infrared frame buffer operatively coupled to the de-mosaicing processor, the infrared frame buffer configured to buffer the infrared pixels;
f) a video interface processor operatively coupled to the color frame buffer and to the infrared frame buffer, the video interface processor configured to produce a color video signal from the buffered red, green and blue pixels produced by the color frame buffer and to produce an infrared video signal from the buffered infrared pixels produced by the infrared frame buffer; and
g) a clock operatively coupled to the pixel digitizer and to the video interface processor, the clock configured to synchronize the operation of the pixel digitizer and the video interface processor.

10. The digital imaging system as set forth in claim 9, wherein the filter array further comprises a plurality of matrices, each of the plurality of matrices comprising 3 columns by 2 rows of color filters.

11. The digital imaging system as set forth in claim 10, wherein each of the plurality of matrices further comprises a top row of red, green and infrared color filters, and a bottom row of green, blue and infrared color filters.

12. The digital imaging system as set forth in claim 9, wherein the IR color filters are sensitive to IR light having a wavelength ranging from 850 nm to 1625 nm.

13. A method for de-mosaicing red, green, blue and infrared pixels from a signal produced by a complementary metal-oxide semiconductor (“CMOS”) light sensor device, the signal corresponding to light passing through a filter array onto the light sensor device, the filter array comprising a mosaic of green, red, green, blue, infrared and infrared color filters, the method comprising the steps of:
a) digitizing the signal to produce a plurality of digitized pixels, each digitized pixel corresponding to light passing through one of the green, red, green, blue, infrared and infrared (“IR”) color filters of the color filter array onto a pixel of the light sensor device;
b) applying a red pixel de-mosaicing algorithm to each digitized red pixel to determine the relative strength of red, green, blue and infrared light components at each digitized red pixel;
c) applying a green pixel de-mosaicing algorithm to each digitized green pixel to determine the relative strength of red, green, blue and infrared light components at each digitized green pixel;
d) applying a blue pixel de-mosaicing algorithm to each digitized blue pixel to determine the relative strength of red, green, blue and infrared light components at each digitized blue pixel; and
e) applying an infrared pixel de-mosaicing algorithm to each digitized infrared pixel to determine the relative strength of red, green, blue and infrared light components at each digitized infrared pixel.

14. The method as set forth in claim 13, wherein the filter array further comprises a plurality of matrices, each of the plurality of matrices comprising 3 columns by 2 rows of color filters.

15. The method as set forth in claim 14, wherein each of the plurality of matrices further comprises a top row of red, green and infrared color filters, and a bottom row of green, blue and infrared color filters.

16. The method as set forth in claim 13, wherein the IR color filters are sensitive to IR light having a wavelength ranging from 850 nm to 1625 nm.

17. A complementary metal-oxide semiconductor (“CMOS”) light sensor device comprising a plurality of pixels, wherein at least a portion of the pixels have been doped or coated wherein the doped or coated pixels comprise increased sensitivity to infrared light.

18. The device as set forth in claim 17, wherein the pixels are doped or coated with Germanium or Phosphor.
